(19) United States
(12) Patent Application Publication
(10) Pub. No.: US 2021/0048807 A1
(43) Pub. Date: Feb. 18, 2021

(54) METHOD OF MODELING MULTI-MODE DEGRADATION PROCESS AND PREDICTING REMAINING USEFUL LIFE

(71) Applicant: SHANDONG UNIVERSITY OF SCIENCE AND TECHNOLOGY, Qingdao (CN)

(72) Inventors: Donghua ZHOU, Qingdao (CN); Maoyin CHEN, Qingdao (CN); Hanwen ZHANG, Qingdao (CN); Haifeng ZHANG, Qingdao (CN); Mingliang LI, Qingdao (CN); Xiao LU, Qingdao (CN)

(73) Assignee: SHANDONG UNIVERSITY OF SCIENCE AND TECHNOLOGY

(21) Appl. No.: 16/475,583

(22) PCT Filed: Jun. 13, 2018
(86) PCT No.: PCT/CN2018/090928

§ 371 Date: Jul. 2, 2019

(30) Foreign Application Priority Data
Mar. 14, 2018 (CN) 201810207540.5

(51) Int. Cl. G05B 23/02; G06K 9/62; G06F 17/18

(52) U.S. Cl. CPC G05B 23/0283; G06F 17/18; G06K 9/6218; G06K 9/6277

(57) ABSTRACT

Disclosed is a method of modeling a multi-mode degradation process and predicting a remaining useful life, which belongs to the technical field of health management. The method comprises the following steps: firstly collecting degradation data of equal-interval sampling; performing change point detection for the degradation data; performing clustering with a degradation rate as a feature for degradation segments segmented by change points; establishing a degradation model comprising mode switching, wherein the mode switching is described by one continuous-time Markov chain; estimating a Hurst exponent in a degradation process by a quadratic variation method; estimating a state transition probability matrix of the Markov chain and both a drift term coefficient and a diffusion term coefficient in each mode by a maximum likelihood method respectively; obtaining an obeying distribution of a drift term under an influence of state switching in a period of time in future based on a Monte Carlo algorithm; and obtaining a distribution of a remaining useful life with a given threshold. The distribution of the remaining useful life of a system or equipment comprising a plurality of degradation modes is predicted more accurately.

### TECHNICAL FIELD

The present disclosure belongs to the technical field of health management, and in particular to a method of modeling a multi-mode degradation process and predicting a remaining useful life.

### BACKGROUND

Prediction of a remaining useful life of industrial equipment can provide effective information for preparing a maintenance strategy and a production decision for equipment, thereby reducing losses resulting from an equipment failure and ensuring security and reliability of a system.

Degradation process modeling is a critical procedure for predicting a remaining useful life. To obtain an accurate prediction result of the remaining useful life, a degradation model should conform to an actual degradation situation as possible. At present, in most existing methods, it is assumed that there are no large working condition change and maintenance operation with equipment within its entire useful life period. However, in an actual industrial production, a plurality of working conditions may exist in an equipment running process, and the equipment will be subjected to regular or condition-based repair or maintenance activities at the same time. These activities may affect a degradation process of the equipment, thereby presenting a plurality of modes in the degradation process. At present, a method of predicting a remaining useful life for automatically identifying a plurality of degradation modes still does not emerge.

Modeling of a multi-mode degradation process and prediction of a remaining useful life mainly have the following difficulties: firstly, it is required to identify the number of degradation modes and the degradation model in each mode according to historical data since degradation mode switching does not have a label; secondly, it is difficult to obtain an analyzed first hitting time distribution since the degradation model includes a fractal Brownian motion which is neither a Markov process nor a semi-martingale; thirdly, a future degradation mode switching condition is unknown, and thus it is required to consider possible degradation mode switching in future during the prediction of the remaining useful life.

### SUMMARY

To solve the above technical problems in the prior art, the present disclosure provides a method of modeling a multi-mode degradation process and predicting a remaining useful life, which is reasonable in design and overcomes the disadvantages of the prior art, producing a good effect.

To achieve the above objects, the following technical solution is adopted in the present disclosure.

A method of modeling a multi-mode degradation process and predicting a remaining useful life includes the following steps:

at step 1, collecting degradation data x₀, x₁, x₂, . . . , xₖ of equipment at equal-interval sampling moments t₀, t₁, t₂, . . . , tₖ respectively, where a sampling interval is τ, and the number of sampling is k;

at step 2, detecting slope change points, denoted as γ₁, γ₂, . . . γⱼ and γⱼ₊₁ . . . , of a historical degradation process according to a change point detection method;

at step 3, obtaining a degradation segment by taking the points γjD and γⱼ₊₁ obtained at step 2 as endpoints, calculating a slope η_{γ}_{ⱼ₊₁} of the degradation segment based on the following formula, and taking the slope η_{γ}_{ⱼ₊₁} as a feature value of the j-th degradation segment;

$${η}_{{γ}_{j + 1}} = \frac{{\sum }_{j = {i}_{γ}}^{{i}_{γ + 1}} ( {x}_{j + 1} - {x}_{j} )}{{i}_{γ + 1} - 1}$$

calculating a local density ρⱼ of the feature value of each degradation segment, and calculating a minimum distance δⱼ of the feature value greater than the local density, where the local density ρⱼ is calculated based on the formula (1):

$${ρ}_{j} = {\sum }_{j} χ ( {d}_{ji} - {d}_{c} ) , \qquad ( 1 )$$

where d_{c} is a truncation distance, dⱼᵢ=|ηᵢ−ηⱼ|, and a function χ(·) is defined as follows:

$$χ ( a ) = \{ \begin{matrix}1 , a < 0 \\ 0 , a \geq 0\end{matrix} ; \qquad ( 2 )$$

and

calculating the minimum distance δⱼ based on the following formula (3):

δⱼ=min_{i:ρ}_{ᵢ}_{>ρ}_{ⱼ}dⱼᵢ (3);

at step 4, if ρⱼ and δⱼ are greater than corresponding thresholds respectively, a line segment obtained with the slope change points γⱼ and γⱼ₊₁ as endpoints being one clustering center; according to this method, denoting the number of the obtained clustering centers as N, that is, clustering the line segments segmented by the slope change points as N categories according to the slopes of the line segments, denoting a degradation mode of a sampling moment u as Φ(u), letting φᵢ=Φ(tᵢ), and denoting time points of changes of the degradation mode as c₁, c₂, . . . ;

at step 5, establishing a degradation model based on the formula (4):

X(t)=X(0)+∫₀^{t}λ[Φ(u)]du+σ_{H}B_{H}(t) (4),

where X(0) refers to an initial value of a degradation process, λ[Φ(u)] refers to a drift term coefficient; if λ(i)˜N(μ_{λ}_{ᵢ}, σ_{λ}_{ᵢ}²), σ_{H} refers to a diffusion term coefficient, B_{H} (t) refers to a standard fractal Brownian motion, and the degradation mode Φ(u) is one continuous-time Markov chain with a transition probability matrix being Q;

$$Q = [ \begin{matrix}- {q}_{1} & {q}_{12} & … & {q}_{1 N} \\ {q}_{21} & - {q}_{2} & … & {q}_{2 N} \\ ⋮ & ⋮ & ⋱ & ⋮ \\ {q}_{N 1} & {q}_{N 2} & … & - {q}_{N}\end{matrix} ] ;$$

at step 6, estimating qⱼ and qᵢⱼ in the transition probability matrix Q of the continuous-time Markov chain according to φ₀, φ₁, φ₂, . . . φₖ based on the formulas (5) and (6):

$$\begin{matrix}{q}_{j} = \frac{{m}_{j}}{{\sum }_{i = 1}^{m ,} {v}_{i}^{( j )}} ; & ( 5 ) \\ {q}_{ij} = \frac{{m}_{ij}}{{m}_{i}} {q}_{i} . & ( 6 )\end{matrix}$$

where mⱼ refers to a number of times that the degradation mode hits and stays in the j-th mode before the moment tₖ, mᵢⱼ refers to a number of times that the degradation mode transits from the i-th mode to the j-th mode before the moment tₖ, and vᵢ^{(j)} refers to a stay time of the degradation mode hitting the j-th mode at the i-th time;

at step 7, estimating a Hurst exponent H of the degradation process based on the formula (7):

$$H = \frac{1}{2} {log}_{2} \frac{E [ {( {\sum }_{j = 1}^{p} {θ}_{j} {x}_{2 ( i + j )} )}^{2} ]}{E [ {( {\sum }_{j = 1}^{p} {θ}_{j} {x}_{i + j} )}^{2} ]} \qquad ( 7 )$$

where θ₁, θ₂, . . . , θₚ refer to wavelet decomposition high-pass filter coefficients of Symlets wavelet function, p refers to a number of order of a vanishing moment of the wavelet function, and E(·) refers to a mathematic expectation;

at step 8, estimating an estimation value λᵢ of the drift term coefficient λ[Φ(u)] in the degradation mode of the i-th segment based on the formula (8) respectively:

$${λ}_{i} = \frac{{\tilde{x}}_{{c}_{i} : {c}_{i + 1}}^{T} {Q}_{{\tilde{x}}_{{c}_{i} : {c}_{i + 1}}}^{- 1} {I}_{i}}{τ {I}_{i}^{T} {Q}_{{\tilde{x}}_{{c}_{i} : {c}_{i + 1}}}^{- 1} {I}_{i}} , \qquad ( 8 )$$

where Iᵢ refers to one cᵢ₊₁−cᵢ-dimension column vector, each element thereof is 1, \tilde{x}_{c}_{ᵢ}_{:c}_{ᵢ₊₁}=[x_{c}_{ᵢ}₊₁−x_{c}_{ᵢ}, x_{c}_{ᵢ}₊₂−x_{c}_{ᵢ}₊₁, . . . , x_{c}_{ᵢ₊₁}−x_{c}_{ᵢ₊₁}₊₁]^{T},

$${Q}_{{\tilde{x}}_{{c}_{i} : {c}_{i + 1}}}$$

refers to one cᵢ₊₁−cᵢ-dimension covariance matrix, and the element in the i-th row and the j-th column thereof is ½[|i−j+1|^{2H}τ^{2H}+|i−j−1|^{2H}τ^{2H}−2|i−j|^{2H}τ^{2H}];

at step 9, estimating an expectation μ_{λ}_{ⱼ} and a variance σ_{λ}_{ⱼ} of the drift term coefficient λ[Φ(u)] in each degradation mode based on the formulas (9) and (10) respectively:

$$\begin{matrix}{μ}_{{λ}_{j}} = \frac{{\sum }_{i = 1}^{{m}_{j}} {λ}_{j , i}}{{m}_{j}} ; & ( 9 ) \\ {{σ}_{λ}}_{j} = \sqrt{\frac{{\sum }_{i = 1}^{{m}_{j}} {( {λ}_{j , i} - {μ}_{{λ}_{j}} )}^{2}}{{m}_{j}}} , & ( 10 )\end{matrix}$$

where λ_{j,i} refers to an estimation value of the drift term coefficient obtained when the j-th degradation mode is hit at the i-th time;

at step 10, estimating a diffusion coefficient σ_{H} based on the formula (11):

$${σ}_{H} = \sqrt{\frac{{( {\tilde{x}}_{0 : k}^{T} - Λτ )}^{T} {Q}_{{\tilde{x}}_{0 : k}}^{- 1} ( {\tilde{x}}_{0 : k}^{T} - Λτ )}{k}} , \qquad ( 11 )$$

where Λ^{T}=[λ₁I₁^{T}, λ₂I₂^{T}, . . . , λₘIₘ^{T}], \tilde{x}_{0:k}=[x₁−x₀, x₂−x₁, . . . , xₖ−x_{k- 1}]^{T}, Q_{\tilde{x}}_{_{0:k}} refers to one k-dimension covariance matrix, and the element in the i-th row and the j-th column thereof is ½[|i−j+1|^{2H}τ^{2H}+|i−j−1|^{2H}τ^{2H}−2|i−j|^{2H}τ^{2H}];

at step 11, letting Ω[Φ(tₖ),lₖ]=∫ₜ_{ₖ}^{t}^{ₖ}^{+l}^{ₖ}λ[Φ(u)]du, and obtaining a numerical distribution ƒ_{Ω[Φ(t}_{ₖ}_{),l}_{ₖ}_{]} of Ω[Φ(tₖ),lₖ] by Monte Carlo method; and

at step 12, for a given failure threshold ω, an approximate distribution of a first hitting time of the degradation process being:

$${f}_{l} ( {l}_{k} ) = {\sum }_{i = 1}^{N} {\int }_{{λ}_{min} {l}_{k}}^{{λ}_{max} {l}_{k}} {p}_{Φ ( {t}_{k} ) i} ( {l}_{k} ) {f}_{Ω ( Φ ( {t}_{k} ) , {l}_{k} )} ( s ) \frac{σ ( {l}_{k} )}{\sqrt{2 π σ ( 0 ) {\int }_{0}^{{l}_{k}} σ ( t ) d t}} \{ \frac{ω - {x}_{k} - s}{{\int }_{0}^{{l}_{k}} σ ( t ) d t} + \frac{λ ( i )}{σ ( {l}_{k} )} \} \times exp \{ - \frac{{( ω - {x}_{k} - s )}^{2}}{2 σ ( 0 ) {\int }_{0}^{{l}_{k}} σ ( t ) d t} \} ds , \qquad ( 12 )$$

where λₘᵢₙ=min{λ(1), λ(2), . . . , λ(N)}, λₘₐₓ=max{λ(1), λ(2), . . . , λ(N)}, p_{Φ(t}_{ₖ}₎ᵢ(lₖ)=P{{|Φ(tₖ+lₖ)}=i|Φ(tₖ)}, and

$$σ ( t ) = {σ}_{H} {\{ \begin{matrix}{{{Σ}_{i = 1}}^{⌊ \frac{t}{τ} ⌋} [ {\int }_{( i - 1 ) \cdot τ}^{i \cdot τ} {c}_{H} {s}^{\frac{1}{2}} {\int }_{⌊ \frac{t}{τ} ⌋ \cdot τ}^{⌊ \frac{t + τ}{τ} ⌋ \cdot τ} {( u - s )}^{H - \frac{3}{2}} {u}^{H - \frac{1}{2}} duds ]}^{2} + \\ {[ {\int }_{⌊ \frac{t}{τ} ⌋ \cdot τ}^{⌊ \frac{t + τ}{τ} ⌋ \cdot τ} {c}_{H} {s}^{\frac{1}{2}} {\int }_{s}^{⌊ \frac{t + τ}{τ} ⌋ \cdot τ} {( u - s )}^{H - \frac{3}{2}} {u}^{H \frac{1}{2}} duds ]}^{2}\end{matrix} \}}^{\frac{1}{2}} \\ {c}_{H} = \sqrt{\frac{2 H Γ ( \frac{3}{2} - H )}{Γ ( \frac{1}{2} + H ) Γ ( 2 - 2 H )}} , \qquad ( 13 ) ;$$

where Γ(·) refers to Gamma function;

Preferably, step 2 specifically including the following steps:

at step 2.1, initializing a parameter, letting γ₁=0, i=1, and i_{γ}=1, and selecting a minimum interval mτ between two change points and a threshold ω_{β} of change point detection;

at step 2.2, calculating a slope of a degradation segment from a previous change point to the i-th point; if i−i_{γ}>m, calculating the slope ηᵢ of the current segment based on the formula (14), and letting i=i+1:

$${η}_{i} = \frac{{{\sum }_{j = {i}_{γ}}}^{i - 1} ( {x}_{j + 1} - {x}_{j} )}{i - {i}_{γ} - 1} ; \qquad ( 14 )$$

at step 2.3, calculating a change point detection index β(i) of the i-th point based on the formula (15):

$$β ( i ) = \frac{\vert {\sum }_{j = 1}^{m} ( {x}_{i} + {η}_{i} j τ - {x}_{j} ) \vert}{\sqrt{1 + {η}^{2}}} ; \qquad ( 15 )$$

at step 2.4, determining whether the change point detection index β(i) of the i-th point exceeds the threshold ω_{β}; if β(i)>ω_{β}, xᵢ being a change point, and letting i_{γ}=i_{γ}+1 and γᵢ_{_{γ}}=i; and

at step 2.5, if i≤k, letting i=i+1, and then, performing step 2.2.

Preferably, step 11 specifically includes the following steps:

at step 11.1, selecting the number n of Monte Carlo samples, and initializing parameters i=1 and v_{i,j}=φₖ;

at step 11.2, generating n random numbers rⱼ obeying a uniform distribution on [0,1];

at step 11.3, for the j-th Monte Carlo sample sequence, letting i=i+1 and v_{i+1,j}=s, where s satisfies

$${\sum }_{w = 1}^{s - 1} {p}_{{v}_{i , j} , w} ( τ ) < {r}_{f} \leq {\sum }_{w = 1}^{s} {p}_{{v}_{i , j} , w} ( τ ) ,$$

and pᵥ_{_{i,j}}_{,w}(τ) refers to a probability that the degradation mode transforms from the v_{i,j}-th mode into the w-th mode over time τ; if i<lₖ/τ, returning to step 11.2; otherwise, performing step 11.4;

at step 11.4, calculating a total time length that each Monte Carlo sample sequence stays in each mode within a time interval (tₖ, tₖ+lₖ), and denoting the length as

$${S}_{s , j} = {\sum }_{i = 1}^{{l}_{k} / τ} I ( {v}_{i , j} = s ) ;$$

and

at step 11.5, calculating a numerical distribution ƒ_{Ω(Φ(t}_{ₖ}_{),l}_{ₖ}₎(x) of Ω[Φ(tₖ),lₖ] based on the formula (16):

$${f}_{Ω ( Φ ( {t}_{k} ) , {l}_{k} )} ( x ) = \frac{{{\sum }^{n}}_{j = 1} I ( {{\sum }_{s = 1}}^{N} {S}_{s , j} λ ( s ) = x )}{n} when \\ {\sum }_{s = 1}^{N} {S}_{s , j} λ ( s ) = x ; \qquad ( 16 )$$

is established,

$$I ( {\sum }_{s = 1}^{N} {S}_{s , j} λ ( s ) = x ) = 1 ;$$

otherwise,

$$I ( {\sum }_{s = 1}^{N} {S}_{s , j} λ ( s ) = x ) = 0 .$$

Beneficial effects brought by the present disclosure are described below.

A method of identifying a degradation mode from historical degradation data in the present disclosure is applicable to a system with state switching, an environment change or a maintenance operation, and thus is closer to an actual situation than the prior art. Different degradation modes are obtained by identification according to the historical data, a degradation model that contains state switching and is based on a fractal Brownian motion is established, and the switching of the degradation mode is described through one continuous-time Markov chain. A state transition probability of the Markov chain and both a drift coefficient and a diffusion coefficient in the degradation model are estimated by a maximum likelihood method respectively. In the present disclosure, to obtain the first hitting time of the degradation process, a numerical distribution of a diffusion term in a future time segment is firstly obtained by a Monte Carlo method, and then, the first hitting time of the degradation process based on the fractal Brownian motion is converted into a time when a standard Brownian motion firstly hits a time-varying threshold containing an uncertainty through one time-space transformation, thereby obtaining a distribution of the remaining useful life of the degradation process.

### BRIEF DESCRIPTION OF THE DRAWINGS

FIG. 1 is a flowchart illustrating a method of modeling a degradation process and predicting a remaining useful life according to an example of the present disclosure.

FIG. 2 is a flowchart illustrating a change point detection method according to an example of the present disclosure.

FIG. 3 is a flowchart illustrating a Monte Carlo method according to an example of the present disclosure.

FIG. 4 is schematic diagram illustrating a temperature degradation curve of a furnace wall of a blast furnace according to an example of the present disclosure.

FIG. 5 is schematic diagram illustrating change point detection results of a temperature degradation curve of a furnace wall of a blast furnace in the first 1200 days according to an example of the present disclosure.

FIG. 6 is a schematic diagram illustrating degradation mode identification results of a temperature degradation curve of a furnace wall of a blast furnace in the first 1200 days according to an example of the present disclosure.

FIG. 7 is a schematic diagram illustrating a prediction result of a remaining useful life of a furnace wall of a blast furnace according to an example of the present disclosure.

### DETAILED DESCRIPTION OF THE EMBODIMENTS

The present disclosure will be further described below in detail in combination with accompanying drawings and specific examples.

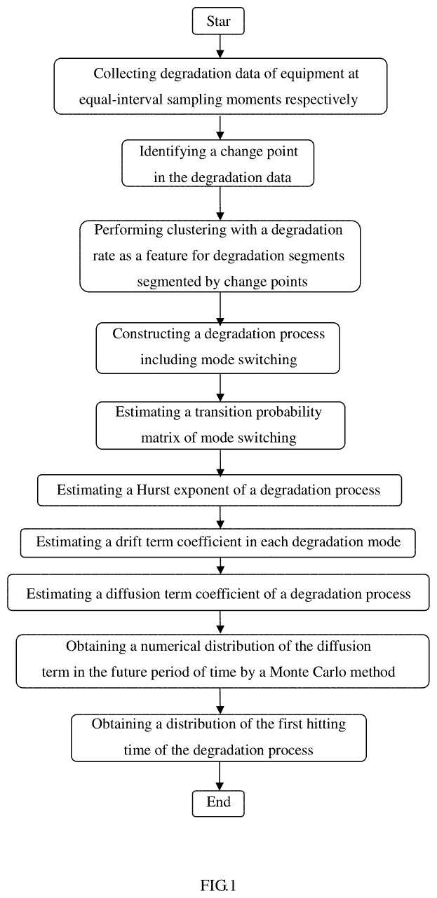

A method of modeling a multi-mode degradation process and predicting a remaining useful life includes the following steps with a flow as shown in FIG. 1:

at step 1, collecting degradation data x₀, x₁, x₂, . . . , xₖ of equipment at equal-interval sampling moments t₀, t₁, t₂, . . . , tₖ respectively, where a sampling interval is τ, and the number of sampling is k;

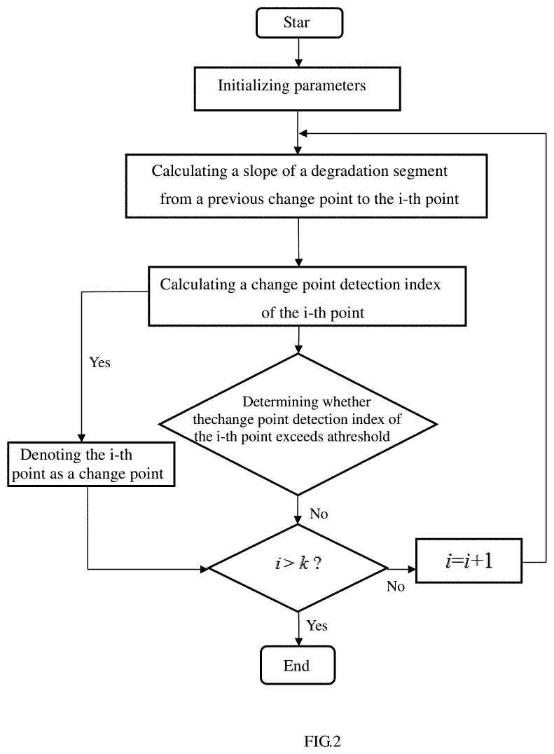

at step 2, detecting slope change points, denoted as γ₁, γ₂, . . . , of a historical degradation process according to a change point detection method (with a flow as shown in FIG. 2);

at step 3, obtaining a degradation segment by taking the points γⱼ and γⱼ₊₁ obtained at step 2 as endpoints, calculating a slope η_{γ}_{ⱼ₊₁}, of the degradation segment based on the following formula, and taking the slope η_{γ}_{ⱼ₊₁} as a feature value of the j-th degradation segment;

$${η}_{{γ}_{j + 1}} = \frac{{{\sum }^{{i}_{γ + 1}}}_{j = {i}_{γ}} ( {x}_{j + 1} - {x}_{j} )}{{i}_{γ + 1} - 1}$$

calculating a local density ρⱼ of a feature value of each degradation segment, and calculating a minimum distance δⱼ of a feature value greater than the local density, where the local density ρⱼ is calculated based on the formula (1):

$${ρ}_{j} = {\sum }_{i} χ ( {d}_{ji} - {d}_{c} ) , \qquad ( 1 )$$

where d_{c} is a truncation distance, dⱼᵢ=|ηᵢ−ηⱼ|, and a function χ(·) is defined as follows:

$$χ ( a ) = \{ \begin{matrix}1 , a < 0 \\ 0 , a \geq 0\end{matrix} ; \qquad ( 2 )$$

and

calculating the minimum distance δⱼ based on the following formula (3):

δⱼ=min_{i:ρ}_{ᵢ}_{>ρ}_{ⱼ}dⱼᵢ (3);

at step 4, if ρⱼ and δⱼ are greater than corresponding thresholds respectively, a line segment obtained with the slope change points γⱼ and γⱼ₊₁ as endpoints being one clustering center; according to this method, denoting the number of the obtained clustering centers as N, that is, clustering the line segments segmented by the slope change points as N categories according to the slopes of the line segments, denoting a degradation mode of a sampling moment u as Φ(u), letting φᵢ=Φ(tᵢ), and denoting time points of changes of the degradation mode as c₁, c₂, . . . ;

at step 5, establishing a degradation model based on the formula (4):

X(t)=X(0)+∫₀^{t}λ[Φ(u)]du+σ_{H}B_{H}(t) (4),

where X(0) refers to an initial value of a degradation process, λ[Φ(u)] refers to a drift term coefficient; if λ(i)˜N(μ_{λ}_{ᵢ}, σ_{λ}_{ᵢ}²), σ_{H} refers to a diffusion term coefficient, B_{H} (t) refers to a standard fractal Brownian motion, and the degradation mode Φ(u) is one continuous-time Markov chain with a transition probability matrix being Q;

$$Q = [ \begin{matrix}- {q}_{1} & {q}_{12} & … & {q}_{1 N} \\ {q}_{21} & - {q}_{2} & … & {q}_{2 N} \\ ⋮ & ⋮ & ⋱ & ⋮ \\ {q}_{N 1} & {q}_{N 2} & … & - {q}_{N}\end{matrix} ] ;$$

at step 6, estimating qⱼ and qᵢⱼ in the transition probability matrix Q of the continuous-time Markov chain according to φ₀, φ₁, φ₂, . . . , φₖ based on the formulas (5) and (6):

$$\begin{matrix}{q}_{j} = \frac{{m}_{j}}{{\sum }_{i = 1}^{{m}_{j}} {v}_{i}^{( j )}} ; & ( 5 ) \\ {q}_{ij} = \frac{{m}_{ij}}{{m}_{i}} {q}_{i} , & ( 6 )\end{matrix}$$

where mⱼ refers to a number of times that the degradation mode hits and stays in the j-th mode before the moment tₖ, mᵢⱼ refers to a number of times that the degradation mode transits from the i-th mode to the j-th mode before the moment tₖ, and vᵢ^{(j)} refers to a stay time of the degradation mode hitting the j-th mode at the i-th time;

at step 7, estimating a Hurst exponent H of the degradation process based on the formula (7):

$$H = \frac{1}{2} {log}_{2} \frac{E [ {( {\sum }_{j = 1}^{p} {θ}_{j} {x}_{2 ( i + j )} )}^{2} ]}{E [ {( {\sum }_{j = 1}^{p} {θ}_{j} {x}_{i + j} )}^{2} ]} , \qquad ( 7 )$$

where θ₁, θ₂, . . . , θₚ refer to wavelet decomposition high-pass filter coefficients of Symlets wavelet function, p refers to a number of order of a vanishing moment of the wavelet function, and E(·) refers to a mathematic expectation;

at step 8, estimating an estimation value λᵢ of a drift term coefficient λ[Φ(u)] in the degradation mode of the i-th segment based on the formula (8) respectively:

$${λ}_{i} = \frac{{\tilde{x}}_{{c}_{i} : {c}_{i + 1}}^{T} {Q}_{{\tilde{x}}_{{c}_{i} : {c}_{i + 1}}}^{- 1} {I}_{i}}{τ {I}_{i}^{T} {Q}_{{\tilde{x}}_{{c}_{i} : {c}_{i + 1}}}^{- 1} {I}_{i}} , \qquad ( 8 )$$

where Iᵢ refers to one cᵢ₊₁−cᵢ-dimension column vector, each element thereof is 1, \tilde{x}_{c}_{ᵢ}_{:c}_{ᵢ₊₁}=[x_{c}_{ᵢ}₊₁−x_{c}_{ᵢ}, x_{c}_{ᵢ}₊₂−x_{c}_{ᵢ}₊₁, . . . , x_{c}_{ᵢ₊₁}−x_{c}_{ᵢ₊₁}₊₁]^{T},

$${Q}_{{\tilde{x}}_{{c}_{i} : {c}_{i + 1}}}$$

refers to one cᵢ₊₁−cᵢ-dimension covariance matrix, and the element in the i-th row and the j-th column thereof is ½[|i−j+1|^{2H}τ^{2H}+|i−j−1|^{2H}τ^{2H}−2|i−j|^{2H}τ^{2H}];

at step 9, estimating an expectation μ_{λ}_{ⱼ} and a variance σ_{λ}_{ⱼ} of the drift term coefficient λ[Φ(u)] in each degradation mode based on the formulas (9) and (10) respectively:

$$\begin{matrix}{μ}_{{λ}_{j}} = \frac{{\sum }_{i = 1}^{{m}_{j}} {λ}_{j , i}}{{m}_{j}} ; & ( 9 ) \\ {σ}_{{λ}_{j}} = \sqrt{\frac{{\sum }_{i = 1}^{{m}_{j}} {( {λ}_{j , i} - {μ}_{{λ}_{j}} )}^{2}}{{m}_{j}}} , & ( 10 )\end{matrix}$$

where λ_{j,i} refers to an estimation value of the drift term coefficient obtained when the j-th degradation mode is hit at the i-th time;

at step 10, estimating a diffusion item coefficient σ_{H} based on the formula (11):

$${σ}_{H} = \sqrt{\frac{{( {\tilde{x}}_{0 : k}^{T} - Λ τ )}^{T} {Q}_{{\tilde{x}}_{0 : k}}^{- 1} ( {\tilde{x}}_{0 : k}^{T} - Λ τ )}{k}} , \qquad ( 11 )$$

where Λ^{T}=[λ₁I₁^{T}, λ₂I₂^{T}, . . . , λₘIₘ^{T}], \tilde{x}_{0:k}=[x₁−x₀, x₂−x₁, . . . , xₖ−x_{k- 1}]^{T}, Q_{\tilde{x}}_{_{0:k}} refers to one k-dimension covariance matrix, and the element in the i-th row and the j-th column thereof is ½[|i−j+1|^{2H}τ^{2H}+|i−j−1|^{2H}τ^{2H}−2|i−j|^{2H}τ^{2H}];

at step 11, letting Ω[Φ(tₖ),lₖ]=∫ₜ_{ₖ}^{t}^{ₖ}^{+l}^{ₖ}λ[Φ(u)]du, and obtaining a numerical distribution ƒ_{Ω[Φ(t}_{ₖ}_{),l}_{ₖ}_{]} of Ω[Φ(tₖ),lₖ] by Monte Carlo method; and

at step 12, for a given failure threshold ω, an approximate distribution of a first hitting time of the degradation process being:

$${f}_{l} ( {l}_{k} ) = {\sum }_{i = 1}^{N} {\int }_{{λ}_{min} {l}_{k}}^{{λ}_{max} {l}_{k}} {p}_{Φ ( {t}_{k} ) i} ( {l}_{k} ) {f}_{Ω ( Φ ( {t}_{k} ) , {l}_{k} )} ( s ) \frac{σ ( {l}_{k} )}{\sqrt{2 π σ ( 0 ) {\int }_{0}^{{l}_{k}} σ ( t ) d t}} \{ \frac{ω - {x}_{k} - s}{{\int }_{0}^{{l}_{k}} σ ( t ) d t} + \frac{λ ( i )}{σ ( {l}_{k} )} \} \times exp \{ \frac{{( ω - {x}_{k} - s )}^{2}}{2 σ ( 0 ) {\int }_{0}^{{l}_{k}} σ ( t ) d t} \} ds , \qquad ( 12 )$$

where λₘᵢₙ=min{λ(1), λ(2), . . . , λ(N)}, λₘₐₓ=max{λ(1), λ(2), . . . , λ(N)}, p_{Φ(t}_{ₖ}₎ᵢ(lₖ)=P{{|Φ(tₖ+lₖ)}=i|Φ(tₖ)}, and

$$\begin{matrix}σ ( t ) = {σ}_{H} {\{ \begin{matrix}{\sum }_{i = 1}^{⌊ \frac{t}{τ} ⌋} {[ {\int }_{( i - 1 ) \cdot τ}^{i \cdot τ} {c}_{H} {s}^{\frac{1}{2}} {\int }_{⌊ \frac{t}{τ} ⌋ \cdot τ}^{⌊ \frac{t + τ}{τ} ⌋ \cdot τ} {( u - s )}^{H - \frac{3}{2}} {u}^{H - \frac{1}{2}} duds ]}^{2} + \\ {[ {\int }_{⌊ \frac{t}{τ} ⌋ \cdot τ}^{⌊ \frac{t + τ}{τ} ⌋ \cdot τ} {c}_{H} {s}^{\frac{1}{2}} {\int }_{s}^{⌊ \frac{t + τ}{τ} ⌋ \cdot τ} {( u - s )}^{H - \frac{3}{2}} {u}^{H - \frac{1}{2}} duds ]}^{2}\end{matrix} \}}^{\frac{1}{2}} ; & 13 ) \\ {c}_{H} = \sqrt{\frac{2 H Γ ( \frac{3}{2} - H )}{Γ ( \frac{1}{2} + H ) Γ ( 2 - 2 H )}} , & \end{matrix}$$

where Γ(·) refers to Gamma function;

Step 2 specifically includes the following steps (with the flow as shown in FIG. 2):

at step 2.1, initializing a parameter, letting γ₁=0, i=1, and i_{γ}=1, and selecting a minimum interval mτ between two change points and a threshold ω_{β} of a change point detection;

at step 2.2, calculating a slope of a degradation segment from a previous change point to the i-th point; if i−i_{γ}>m, calculating the slope ηᵢ of the current segment based on the formula (14), and letting i=i+1:

$${η}_{i} = \frac{{\sum }_{j = {i}_{γ}}^{i - 1} ( {x}_{j + 1} - {x}_{j} )}{i - {i}_{γ} - 1} ; \qquad ( 14 )$$

at step 2.3, calculating a change point detection index β(i) of the i-th point based on the formula (15):

$$β ( i ) = \frac{\vert {\sum }_{j = 1}^{m} ( {x}_{i} + {η}_{i} j τ - {x}_{j} ) \vert}{\sqrt{1 + {η}_{i}^{2}}} ; \qquad ( 15 )$$

at step 2.4, determining whether the change point detection index β(i) of the i-th point exceeds the threshold ω_{β}; if β(i)>ω_{β}, xᵢ being a change point, and letting i_{γ}=i_{γ}+1 and γᵢ_{_{γ}}=i; and

at step 2.5, if i≤k, letting i=i+1, and then, performing step 2.2.

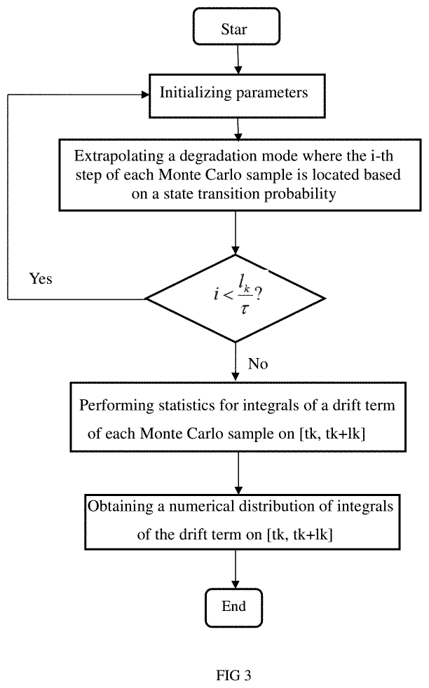

Step 11 specifically includes the following steps (with a flow as shown in FIG. 3):

at step 11.1, selecting the number n of Monte Carlo samples, and initializing parameters i=1 and v_{i,j}=φₖ;

at step 11.2, generating n random numbers rⱼ obeying a uniform distribution on [0,1];

at step 11.3, for the j-th Monte Carlo sample sequence, letting i=i+1 and v_{i+1,j}=s, where s satisfies

$${\sum }_{w = 1}^{s - 1} {p}_{{v}_{i , j} , w} ( τ ) < {r}_{j} \leq {\sum }_{w = 1}^{s} {p}_{{v}_{i , j} , w} ( τ ) ,$$

and pᵥ_{_{i,j}}_{,w}(τ) refers to a probability that the degradation mode transforms from the v_{i,j}-th mode into the w-th mode over time τ; if i<lₖ/τ, returning to step 11.2; otherwise, performing step 11.4;

at step 11.4, calculating a total time length that each Monte Carlo sample sequence stays in each mode within a time interval (tₖ, tₖ+lₖ), and denoting the length as

$${S}_{s , j} = {\sum }_{i = 1}^{{l}_{k} / τ} I ( {v}_{i , j} = s ) ;$$

and

at step 11.5, calculating a numerical distribution of ƒ_{Ω(Φ(t}_{ₖ}_{),l}_{ₖ}₎(x) of Ω[Φ(tₖ),lₖ] based on the formula (16):

$$\begin{matrix}{f}_{Ω ( Φ ( {t}_{k} ) , {l}_{k} )} ( x ) = \frac{{{\sum }^{n}}_{j = 1} I ( {{\sum }^{n}}_{s = 1} {S}_{s , j} λ ( s ) = x )}{n} ; when & ( 16 ) \\ {\sum }_{s = 1}^{N} {S}_{s , j} λ ( s ) = x & \end{matrix}$$

is established,

$$I ( {\sum }_{s = 1}^{N} {S}_{s , j} λ ( s ) = x ) = 1 ;$$

otherwise,

$$I ( {\sum }_{s = 1}^{N} {S}_{s , j} λ ( s ) = x ) = 0 .$$

The present disclosure will be described with data of No. 2 blast furnace in Liuzhou Iron & Steel Company based on a MATLAB tool in this example so as to show effects of the present disclosure in combination with accompanying drawings.

(1) Temperature sensor data of a furnace wall of a blast furnace is collected, temperature data (selecting a daily average temperature value) collected continuously by a thermocouple at a height of 8.2 meters for 1506 days is selected denoted as x₀, x₁, x₂, . . . , x₁₅₀₆, and degradation data is as shown in FIG. 4.

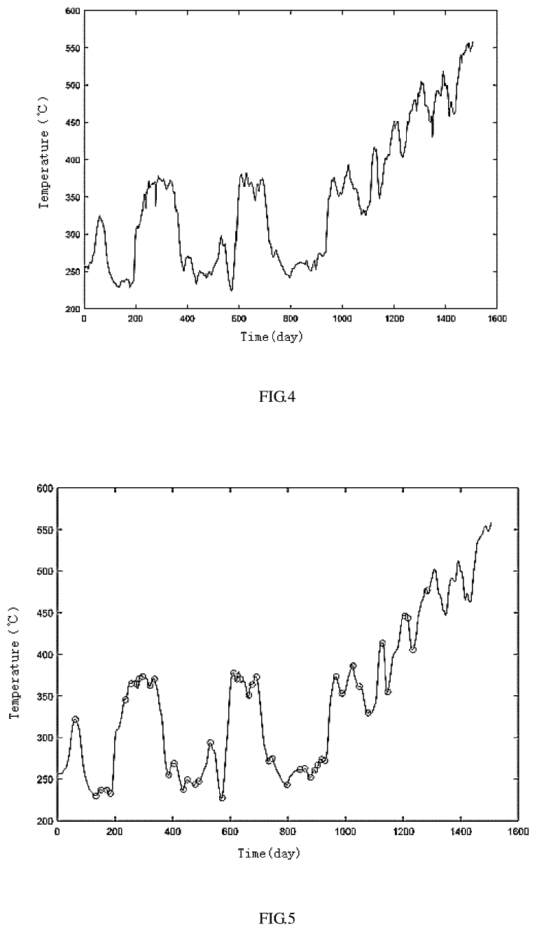

(2) Change points, denoted as γ₁, γ₂, . . . , before a moment tₖ are detected based on a change point detection algorithm, and a change point detection result is as shown in FIG. 5 (for example, tₖ=1300).

(3) A slope of a line segment segmented by the change points is calculated based on the formula (14) respectively.

(4) A local density ρⱼ of each line segment and a minimum distance δⱼ of a line segment greater than the density of the line segment are calculated based on the formulas (1), (2) and (3) respectively.

(5) The line segments in which ρⱼ>2 and δⱼ>26 are selected as clustering centers, and a total of three clustering centers are obtained, that is, N=3.

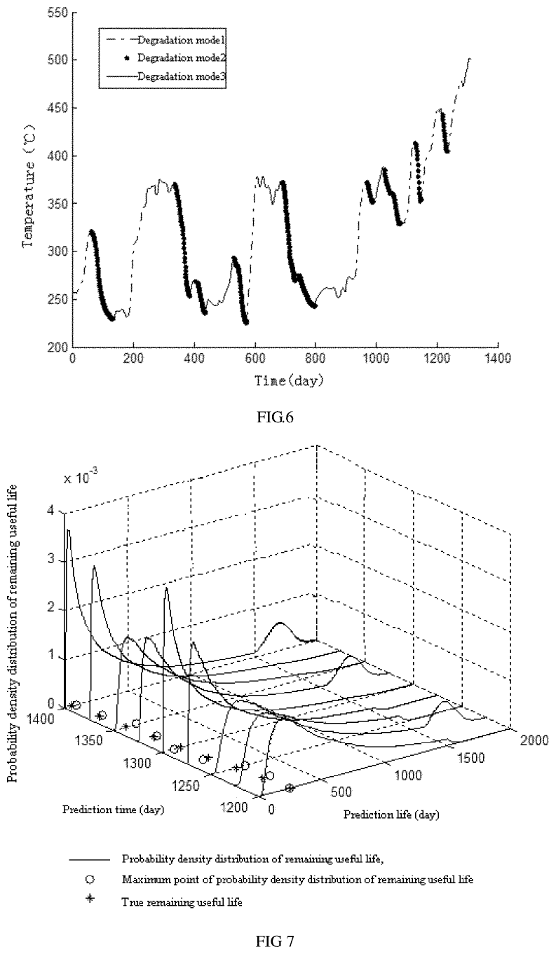

(6) The clustering of the line segments is completed by calculating a clustering center closest to each line segment respectively, and a clustering result is obtained as shown in FIG. 6.

(7) An estimation value of a state transition probability matrix of Markov chain is obtained based on the formulas (5) and (6).

(8) A estimation value H=0.8959 of a Hurst exponent of a degradation process is obtained based on the formula (7).

(9) An estimation value of a drift term coefficient of each segment of degradation path is obtained based on the formula (8).

(10) An expectation and a variance of the drift term coefficient in each degradation mode are obtained based on the formulas (9) and (10) respectively.

(11) An estimation value σ_{H}=1.0599 of a diffusion term coefficient is obtained based on the formula (11).

(12) A numerical solution ƒ_{Ω[Φ(t}_{ₖ}_{),l}_{ₖ}_{]} of a distribution Ω[Φ(tₖ),lₖ] is obtained based on the Monte Carlo algorithm.

(13) If the threshold is 530° C., a prediction result of a remaining useful life distribution at the k-th sampling moment is obtained based on the formula (12).

As can be seen from the temperature degradation curve of the furnace wall of the blast furnace wall that the temperature threshold 530° C. is hit for the first time at the 1456-th day. Results shown in FIG. 7 are obtained by performing prediction of the remaining useful life on the 1300-th, 1310-th, 1320-th, 1330-th, 1340-th, 1350-th, 1360-th, 1370-th, 1380-th, 1390-th and 1400-th days respectively. It can be seen that true values of the remaining useful life are all located at positions with higher probability densities of prediction results, thereby verifying effectiveness of the method provided by the present disclosure.

Of course, the above descriptions are not intended to limit the present disclosure, and the present disclosure is also not limited to the above examples. Variations, modifications, additions or substitutions made by persons of ordinary skill in the art shall also belong to the scope of protection of the present disclosure.

1. A method of modeling a multi-mode degradation process and predicting a remaining useful life, comprising the following steps:
at step 1, collecting degradation data x₀, x₁, x₂, . . . , xₖ of equipment at equal-interval sampling moments t₀, t₁, t₂, . . . , tₖ respectively, where a sampling interval is τ, and the number of sampling is k;
at step 2, detecting slope change points, denoted as γ₁, γ₂, . . . , γⱼ, γⱼ₊₁ . . . , of a historical degradation process according to a change point detection method;
at step 3, obtaining a degradation segment by taking the points γⱼ and γⱼ₊₁ obtained at step 2 as endpoints, calculating a slope η_{γ}_{ⱼ₊₁}, of the degradation segment based on the following formula, and taking the slope η_{γ}_{ⱼ₊₁} as a feature value of the j-th degradation segment;
$${η}_{{γ}_{j + 1}} = \frac{{{\sum }^{{i}_{γ + 1}}}_{j = {i}_{γ}} ( {x}_{j + 1} - {x}_{j} )}{{i}_{γ + 1} - 1}$$
calculating a local density ρⱼ of the feature value of each degradation segment, and calculating a minimum distance δⱼ of a feature value greater than the local density, wherein the local density ρⱼ is calculated based on the formula (1):
$${ρ}_{j} = {\sum }_{i} χ ( {d}_{ji} - {d}_{c} ) , \qquad ( 1 )$$
wherein d_{c} is a truncation distance, dⱼᵢ=|ηᵢ−ηⱼ|, and a function χ(·) is defined as follows:
$$χ ( a ) = \{ \begin{matrix}l , & a < 0 \\ 0 , & a \geq 0\end{matrix} ; \qquad ( 2 )$$
and
calculating the minimum distance δⱼ based on the following formula (3):
δⱼ=min_{i:ρ}_{ᵢ}_{>ρ}_{ⱼ}dⱼᵢ (3);
at step 4, if ρⱼ and δⱼ are greater than corresponding thresholds respectively, a line segment obtained with the slope change points γⱼ and γⱼ₊₁ as endpoints being one clustering center; according to this method, denoting the number of the obtained clustering centers as N, that is, clustering the line segments segmented by the slope change points as N categories according to the slopes of the line segments, denoting a degradation mode of a sampling moment u as Φ(u), letting φᵢ=Φ(tᵢ), and denoting time points of changes of the degradation mode as c₁, c₂, . . . ;
at step 5, establishing a degradation model based on the formula (4):
X(t)=X(0)+∫₀^{t}λ[Φ(u)]du+σ_{H}B_{H}(t) (4),
where X(0) refers to an initial value of a degradation process, λ[Φ(u)] refers to a drift term coefficient; when λ(i)˜N(μ_{λ}_{ᵢ}, σ_{λ}_{ᵢ}²), σ_{H} refers to a diffusion term coefficient, B_{H} (t) refers to a standard fractal Brownian motion, and the degradation mode Φ(u) is one continuous-time Markov chain with a transition probability matrix being Q;
$$Q = [ \begin{matrix}- {q}_{1} & {q}_{12} & … & {q}_{1 N} \\ {q}_{21} & - {q}_{2} & … & {q}_{2 N} \\ ⋮ & ⋮ & ⋱ & ⋮ \\ {q}_{N 1} & {q}_{N 2} & … & - {q}_{N}\end{matrix} ] ;$$
at step 6, estimating qⱼ and qᵢⱼ in the transition probability matrix Q of the continuous-time Markov chain according to φ₀, φ₁, φ₂, . . . , φₖ based on the formulas (5) and (6):
$$\begin{matrix}{q}_{j} = \frac{{m}_{j}}{{\sum }_{i = 1}^{{m}_{j}} {v}_{i}^{( j )}} ; & ( 5 ) \\ {q}_{ij} = \frac{{m}_{ij}}{{m}_{i}} {q}_{i} , & ( 6 )\end{matrix}$$
wherein mⱼ refers to a number of times that the degradation mode hits and stays in the j-th mode before the moment tₖ, mᵢⱼ refers to a number of times that the degradation mode transits from the i-th mode to the j-th mode before the moment tₖ, and vᵢ^{(j)} refers to a stay time of the degradation mode hitting the j-th mode at the i-th time;
at step 7, estimating a Hurst exponent H of the degradation process based on the formula (7):
$$H = \frac{1}{2} {log}_{2} \frac{E [ {( {\sum }_{j = 1}^{p} {θ}_{j} {x}_{2 ( i + j )} )}^{2} ]}{E [ {( {\sum }_{j = 1}^{p} {θ}_{j} {x}_{i + j} )}^{2} ]} , \qquad ( 7 )$$
wherein θ₁, θ₂, . . . , θₚ refer to wavelet decomposition high-pass filter coefficients based on Symlets wavelet function, p refers to a number of order of a vanishing moment of the wavelet function, and E(·) refers to a mathematic expectation;
at step 8, estimating an estimation value λᵢ of a drift term coefficient λ[Φ(u)] in the degradation mode of the i-th segment based on the formula (8) respectively:
$${λ}_{i} = \frac{{\tilde{x}}_{{c}_{i} : {c}_{i + 1}}^{T} {Q}_{{\tilde{x}}_{{c}_{i} : {c}_{i + 1}}}^{- 1} {I}_{i}}{τ {I}_{i}^{T} {Q}_{{\tilde{x}}_{{c}_{i} : {c}_{i + 1}}}^{- 1} {I}_{i}} , \qquad ( 8 )$$
wherein Iᵢ refers to one cᵢ₊₁−cᵢ-dimension column vector, each element of the column vector is 1, \tilde{x}_{c}_{ᵢ}_{:c}_{ᵢ₊₁}=[x_{c}_{ᵢ}₊₁−x_{c}_{ᵢ}, x_{c}_{ᵢ}₊₂−x_{c}_{ᵢ}₊₁, . . . , x_{c}_{ᵢ₊₁}−x_{c}_{ᵢ₊₁}₊₁]^{T},
$${Q}_{{\tilde{x}}_{{c}_{i} : {c}_{i + 1}}}$$
refers to one cᵢ₊₁−cᵢ-dimension covariance matrix, and the element in the i-th row and the j-th column of the covariance matrix is ½[|i−j+1|^{2H}τ^{2H}+|i−j−1|^{2H}τ^{2H}−2|i−j|^{2H}τ^{2H}];
at step 9, estimating an expectation μ_{λ}_{ⱼ} and a variance σ_{λ}_{ⱼ} of the drift term coefficient λ[Φ(u)] in each degradation mode based on the formulas (9) and (10) respectively:
$$\begin{matrix}{μ}_{{λ}_{j}} = \frac{{\sum }_{i = 1}^{{m}_{j}} {λ}_{j , i}}{{m}_{j}} ; & ( 9 ) \\ {σ}_{{λ}_{j}} = \sqrt{\frac{{\sum }_{i = 1}^{{m}_{j}} {( {λ}_{j , i} - {μ}_{{λ}_{j}} )}^{2}}{{m}_{j}}} , & ( 10 )\end{matrix}$$
wherein λ_{j,i} refers to an estimation value of the drift term coefficient obtained when the j-th degradation mode is hit at the i-th time;
at step 10, estimating a diffusion term coefficient σ_{H} based on the formula (11):
$${σ}_{H} = \sqrt{\frac{{( {\tilde{x}}_{0 : k}^{T} - Λ τ )}^{T} {Q}_{{\tilde{x}}_{0 : k}}^{- 1} ( {\tilde{x}}_{0 : k}^{T} - Λτ )}{k}} , \qquad ( 11 )$$
wherein Λ^{T}=[λ₁I₁^{T}, λ₂I₂^{T}, . . . , λₘIₘ^{T}], \tilde{x}_{0:k}=[x₁−x₀, x₂−x₁, . . . , xₖ−xₖ₋₁]^{T}, Q_{\tilde{x}}_{_{0:k}} refers to one k-dimension covariance matrix, and the element in the i-th row and the j-th column of the covariance matrix is ½[|i−j+1|^{2H}τ^{2H}+|i−j−1|^{2H}τ^{2H}−2|i−j|^{2H}τ^{2H}];
at step 11, letting Ω[Φ(tₖ),lₖ]=∫ₜ_{ₖ}^{t}^{ₖ}^{+l}^{ₖ}λ[Φ(u)]du, and obtaining a numerical distribution ƒ_{Ω[Φ(t}_{ₖ}_{),l}_{ₖ}_{]} of Ω[Φ(tₖ),lₖ] by Monte Carlo method; and
at step 12, for a given failure threshold ω, an approximate distribution of a first hitting time of the degradation process being:
$${f}_{l} ( {l}_{k} ) = {\sum }_{i = 1}^{N} {\int }_{{λ}_{min} {l}_{k}}^{{λ}_{max} {l}_{k}} {p}_{Φ ( {t}_{k} ) i} ( {l}_{k} ) {f}_{Ω ( Φ ( {t}_{k} ) , {t}_{k} )} ( s ) \frac{σ ( {l}_{k} )}{\sqrt{2 π σ ( 0 ) {\int }_{0}^{{l}_{k}} σ ( t ) d t}} \{ \frac{ω - {x}_{k} - s}{{\int }_{0}^{{l}_{k}} σ ( t ) d t} + \frac{λ ( i )}{σ ( {l}_{k} )} \} \times exp \{ - \frac{{( ω - {x}_{k} - s )}^{2}}{2 σ ( 0 ) {\int }_{0}^{{l}_{k}} σ ( t ) d t} \} ds , \qquad ( 12 )$$
wherein λₘᵢₙ=min{λ(1), λ(2), . . . , λ(N)}, λₘₐₓ=max{λ(1), λ(2), . . . , λ(N)}, p_{Φ(t}_{ₖ}₎ᵢ(lₖ)=P{{|Φ(tₖ+lₖ)}=i|Φ(tₖ)}, and
$$\begin{matrix}σ ( t ) = {σ}_{H} {\{ \begin{matrix}{\sum }_{i = 1}^{⌊ \frac{t}{τ} ⌋} {[ {\int }_{( i - 1 ) \cdot τ}^{i \cdot τ} {c}_{H} {s}^{\frac{1}{2}} {\int }_{⌊ \frac{t}{τ} ⌋ \cdot τ}^{⌊ \frac{t + τ}{τ} ⌋ \cdot τ} {( u - s )}^{H - \frac{3}{2}} {u}^{H - \frac{1}{2}} duds ]}^{2} + \\ {[ {\int }_{⌊ \frac{t}{τ} ⌋ \cdot τ}^{⌊ \frac{t + τ}{τ} ⌋ \cdot τ} {c}_{H} {s}^{\frac{1}{2}} {\int }_{s}^{⌊ \frac{t + τ}{τ} ⌋ \cdot τ} {( u - s )}^{H - \frac{3}{2}} {u}^{H - \frac{1}{2}} duds ]}^{2}\end{matrix} \}}^{\frac{1}{2}} ; & 13 ) \\ {c}_{H} = \sqrt{\frac{2 H Γ ( \frac{3}{2} - H )}{Γ ( \frac{1}{2} + H ) Γ ( 2 - 2 H )}} , & \end{matrix}$$
wherein Γ(·) refers to a Gamma function.

2. The method according to claim 1, wherein the step 2 specifically comprises the following steps:
at step 2.1, initializing parameters, letting γ₁=0, i=1, and i_{γ}=1, and selecting a minimum interval mτ between two change points and a threshold ω_{β} of a change point detection;
at step 2.2, calculating the slope of the degradation segment from a previous change point to the i-th point; when i−i_{γ}>m, calculating the slope ηᵢ of the current segment based on the formula (14), and letting i=i+1:
$${η}_{i} = \frac{{\sum }_{j = {i}_{γ}}^{{ }_{i - 1}} ( {x}_{j + 1} - {x}_{j} )}{i - {i}_{γ} - 1} ; \qquad ( 14 )$$
at step 2.3, calculating a change point detection index β(i) of the i-th point based on the formula (15):
$$β ( i ) = \frac{\vert {\sum }_{j = 1}^{m} ( {x}_{i} + {η}_{i} j τ - {x}_{j} ) \vert}{\sqrt{1 + {η}_{i}^{2}}} ; \qquad ( 15 )$$
at step 2.4, determining whether the change point detection index β(i) of the i-th point exceeds the threshold ω_{β}; when β(i)>ω_{β}, xᵢ being a change point, and letting i_{γ}=i_{γ}+1 and γᵢ_{_{γ}}=i; and
at step 2.5, when i≤k, letting i=i+1, and then performing step 2.2.

3. The method according to claim 1, wherein the step 11 specifically comprises the following steps:
at step 11.1, selecting the number n of Monte Carlo samples, and initializing parameters i=1 and v_{i,j}=φₖ;
at step 11.2, generating n random numbers rⱼ obeying a uniform distribution on [0,1]; and
at step 11.3, for the j-th Monte Carlo sample sequence, letting i=i+1 and v_{i+1,j}=s, wherein s satisfies
$${\sum }_{w = 1}^{s - 1} {p}_{{v}_{i , j} , w} ( τ ) < {r}_{j} \leq {\sum }_{w = 1}^{s} {p}_{{v}_{i , j} , w} ( τ ) ,$$
and pᵥ_{_{i,j}}_{,w}(τ) refers to a probability that the degradation mode transforms from the v_{i,j}-th mode into the w-th mode over time τ; when i<lₖ/τ, returning to step 11.2; otherwise, performing step 11.4;
at step 11.4, calculating a total time length of each Monte Carlo sample sequence staying in each mode within a time interval (tₖ, tₖ+lₖ), and denoting the length as
$${S}_{s , j} = {\sum }_{i = 1}^{{l}_{k} / τ} I ( {v}_{i , j} = s ) ;$$
and
at step 11.5, calculating a numerical distribution ƒ_{Ω(Φ(t}_{ₖ}_{),l}_{ₖ}₎(x) of Ω[Φ(tₖ),lₖ] based on the formula (16):
$$\begin{matrix}{f}_{Ω ( Φ ( {t}_{k} ) , {l}_{k} )} ( x ) = \frac{{\sum }_{j = 1}^{n} I ( {\sum }_{s = 1}^{N} {S}_{s , j} λ ( s ) = x )}{n} ; & ( 16 ) \\ when {\sum }_{s = 1}^{N} {S}_{s , j} λ ( s ) = x & \end{matrix}$$
is established,
$$I ( {\sum }_{s = 1}^{N} {S}_{s , j} λ ( s ) = x ) = 1 ;$$
otherwise,
$$I ( {\sum }_{s = 1}^{N} {S}_{s , j} λ ( s ) = x ) = 0.$$
